(19) United States
(12) Patent Application Publication
(10) Pub. No.: US 2018/0278199 A1
(43) Pub. Date: Sep. 27, 2018

(54) FLOATING SOLAR PANEL ERECTION STRUCTURE

(71) Applicant: Chicony Power Technology Co., Ltd., New Taipei City (TW)

(72) Inventor: Meng-Fang CHANG, New Taipei City (TW)

(21) Appl. No.: 15/594,651

(22) Filed: May 14, 2017

(30) Foreign Application Priority Data
Mar. 23, 2017 (TW) 106109807

(51) Int. Cl. H02S 20/30; B63B 35/44; H02S 10/40

(52) U.S. Cl. CPC H02S 20/30; B63B 2035/4453; H02S 10/40; B63B 35/44

(57) ABSTRACT

A floating solar panel erection structure includes a floating platform, an angle adjustment mechanism and an angle restriction mechanism. The floating platform includes a chute, a first anchoring mechanism and a second anchoring mechanism. The angle adjustment mechanism includes a first link, a second link and a third link that are pivotally connected to the floating platform. The first link and the third link have first ends pivotally connected to the floating platform, the second link have two opposite ends pivotally connected to second opposite ends of the first link and the third link, and the second link is for erecting a solar panel thereon. The angle restriction mechanism has a latch link to be coupled to the third link, and an end of the latch link is connected with a sliding projection which is slidably connected within the chute.

### CROSS-REFERENCE TO RELATED APPLICATION

This application claims priority to Taiwan Application Serial Number 106109807, filed Mar. 23, 2017, which is herein incorporated by reference.

### BACKGROUND

### Field of Invention

The present invention relates to solar panel erection structure and, more particularly, to a solar panel erection structure installed on water.

### Description of Related Art

A conventional floating solar power generation platform is erected on water with its solar panel tilt 0-15 degrees from a horizontal plane so as to shelter against winds and water waves as well as maintenance difficulties and serious corrosion problems, thereby reducing maintenance costs. However, such practices only are 70% efficiency of full-sun-tracking solar power generation modules.

When the solar panel is tilted too much, e.g., greater than 15 degrees, and located within an extreme environments (such as typhoons), a wind resistance of the overall platform will be reduced.

How to improve the power generation efficiency and equip the ability to resist wind as well within the limited cost is still an important aspect for erecting a floating solar power generation platform.

### SUMMARY

The present disclosure provides a floating solar panel erection structure including a floating platform, an angle adjustment mechanism and an angle restriction mechanism. The floating platform includes a chute, a first anchoring mechanism and a second anchoring mechanism. The angle adjustment mechanism includes a first link, a second link and a third link that are pivotally connected to the floating platform. The first link and the third link have first ends pivotally connected to the floating platform, the second link have two opposite ends pivotally connected to second opposite ends of the first link and the third link, and the second link is for erecting a solar panel thereon. The angle restriction mechanism has a latch link to be coupled to the third link, and an end of the latch link is connected with a sliding projection which is slidably connected within the chute.

In one or more embodiments, the latch link has a first latch hole and a second latch hole, and the third link has a through hole and a third latch hole, the latch link is perpendicular to the third link and slidably connected within the through hole, a latch is inserted to secure a position relationship among the first, second, third links and the latch link when the third latch hole is aligned with the first or second latch hole.

In one or more embodiments, the third latch hole is aligned within the first latch hole when the sliding projection is slid to a first end of the chute; and the third latch hole is aligned within the second latch hole when the sliding projection is slid to a second end of the chute.

In one or more embodiments, the through hole is located at a bisected position of the third link.

In one or more embodiments, the through hole and the third latch hole extend along directions that are perpendicular to each other.

In one or more embodiments, the chute has a lengthwise direction parallel to a horizontal plane when the floating platform is located on water.

In one or more embodiments, the first, second, third links and the floating platform are pivotally connected by a coupling device.

In one or more embodiments, the coupling device includes a base portion, a pair of first and second projection portions extending from the base portion, and a pivot engaging mechanism.

In one or more embodiments, the pivot engaging mechanism includes a pivot rod passing through the pair of first and second projection portions and two cap nuts securing two opposite ends of the pivot rod.

In one or more embodiments, the first link, the second link and the third link have a length ratio of 3:8:7.

In sum, the floating solar panel erection structure disclosed herein is equipped with a four-link mechanism as the angle adjustment mechanism, and equipped with the latch link and the sliding projection as the angle restriction mechanism so as to adjust the tilt angle for the solar panel under different application cases. Therefore, the floating solar panel erection structure is conducive to wind, waves or to have better power generation performance under certain seasons or time.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a perspective view of a floating solar panel erection structure according to one embodiment of the present disclosure;

FIG. 2 illustrates a side view of the floating solar panel erection structure in FIG. 1 in a first application case;

FIG. 3 illustrates a side view of the floating solar panel erection structure in FIG. 1 in a second application case;

FIG. 4 illustrates an enlarged view of the portion A in FIG. 2; and

FIG. 5 illustrates a perspective view of a coupling device according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

An aspect of the present disclosure is to provide a floating solar panel erection structure which is capable of adjusting the tilt angle for the solar panel under different application cases, thereby enabling the solar panel to be conducive to wind, waves or to have better power generation performance under certain seasons or time.

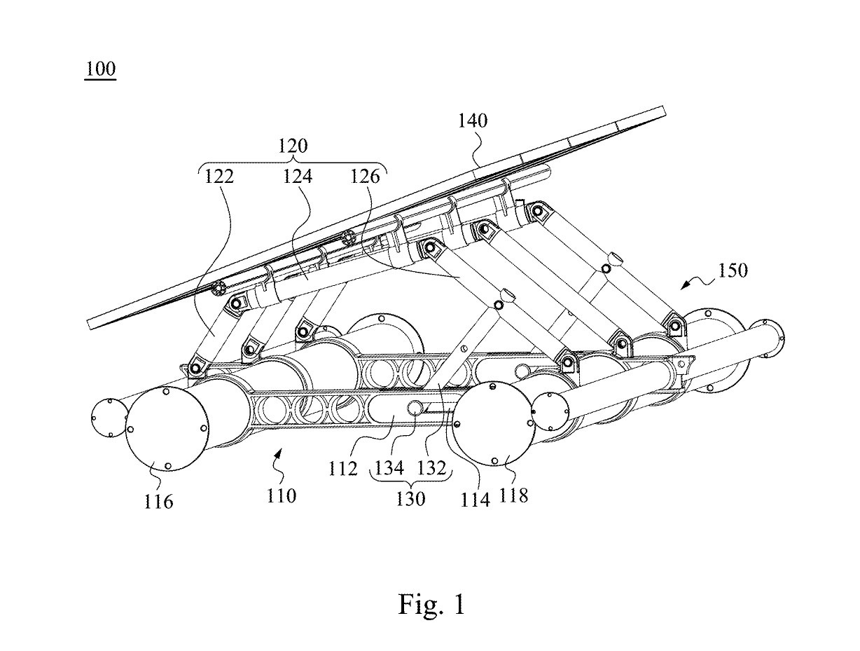

FIG. 1 illustrates a perspective view of a floating solar panel erection structure according to one embodiment of the present disclosure. The floating solar panel erection structure 100 includes a floating platform 110, an angle adjustment mechanism 120 and an angle restriction mechanism 130. The floating platform 110 includes a chute 114, a first anchoring mechanism 116 and a second anchoring mechanism 118. The angle adjustment mechanism 120 is coupled to the floating platform 110, and basically includes a first link 122, a second link 124 and a third link 126 that are all pivotally connected with each other and pivotally connected to the floating platform 110. The first link 122 and the third link 126 have their first ends pivotally connected to the floating platform 110, and the second link 124 has two opposite ends pivotally connected to second opposite ends of the first link 122 and the third link 126. The second link 124 is utilized to erect and support a solar panel 140 thereon. The angle restriction mechanism 130 includes a latch link 132 to be coupled to the third link 126, and an end of the latch link 132 is connected with a sliding projection 134 which is slidably connected within the chute 114 of the floating platform 110.

In one embodiment of the present invention, the floating platform 110 includes three sets of angle adjustment mechanisms 120 and two sets of angle restriction mechanisms 130. Those skilled in the art may vary the number of sets for the angle adjustment mechanism 120 and the angle restriction mechanism 130 respectively according to actual demands.

The floating platform 110 is erected based on its bottom frame 112, and the first anchoring mechanism 116 and the second anchoring mechanism 118 are located at two opposite ends of the chute 114. The first anchoring mechanism 116 and the second anchoring mechanism 118 can be hollow tubes that are made from moisture-resistant and anti-oxidation materials, and the flanges at two opposite ends of each anchoring mechanism are equipped with screw holes allowing multiple floating platforms to be interconnected or secured.

In one embodiment of the present invention, the chute 114 has a lengthwise direction parallel to a horizontal plane when the floating platform 110 is located on water, e.g., calm water.

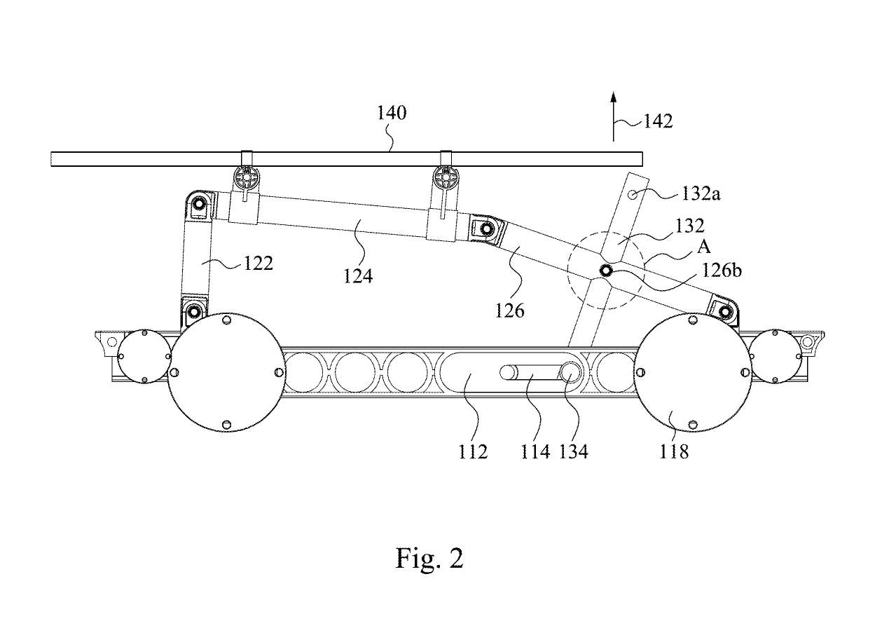

FIG. 2 illustrates a side view of the floating solar panel erection structure in FIG. 1 in a first application case. Under the first application case, the solar panel 140 is parallel to the horizontal plane with zero degree tilted angle such the floating solar panel erection structure is conducive to wind, waves or to have better power generation performance under certain seasons or time, e.g., summer.

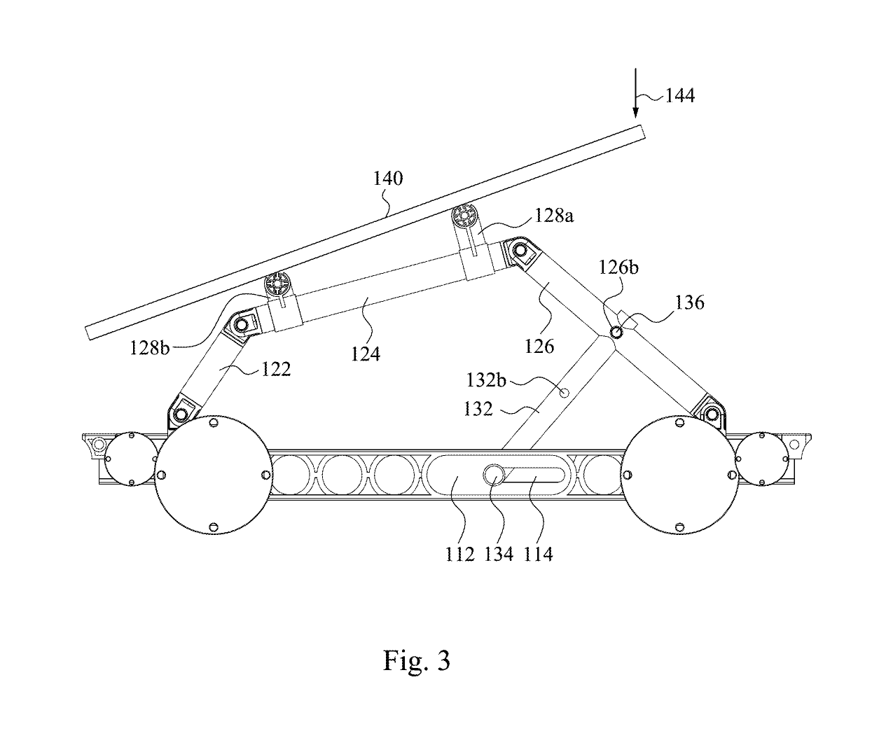

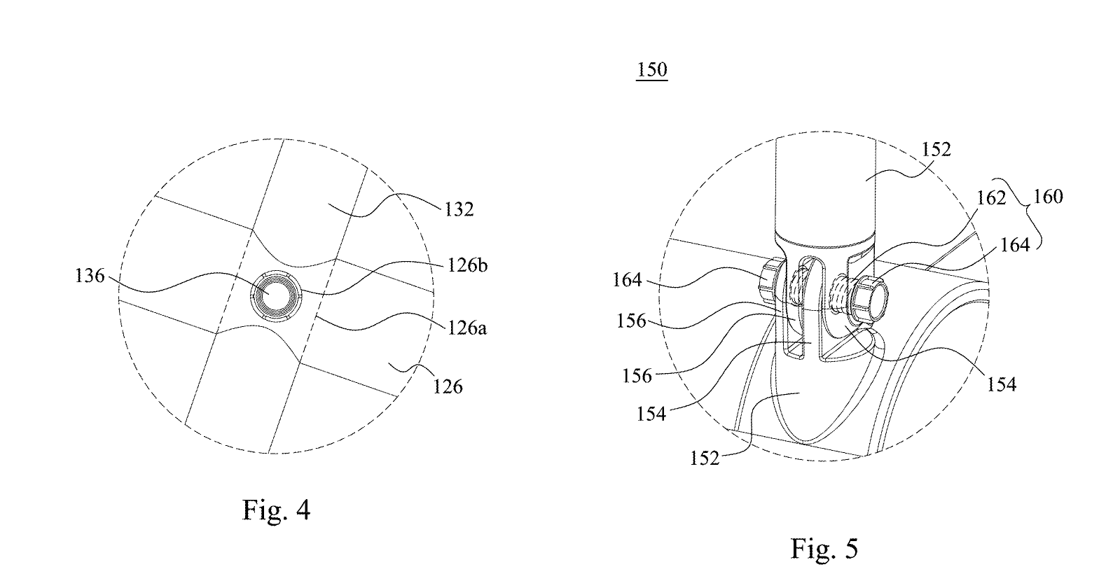

Reference is made to FIGS. 2 and 4, and FIG. 4 illustrates an enlarged view of the portion A in FIG. 2. The latch link 132 of the angle restriction mechanism 130 has a first latch hole 132a and a second latch hole 132b (see FIG. 3), and the third link 126 has a through hole 126a and a third latch hole 126b. The latch link 132 is perpendicular to the third link 126 and slidably connected within the through hole 126a. When the third latch hole 126b is aligned with the first or second latch holes (132a, 132b), a latch 136 is inserted to secure a position relationship among the first link 122, the second link 124, the third link 126 and the latch link 132.

Under the first application case (see FIG. 2), the sliding projection 134 is slid to an right end of the chute 114, and the third latch hole 126b of the third link 126 is aligned with the second latch hole 132b of the latch link 132. The latch 136 is inserted into the aligned latch holes to secure the position relationship among the first link 122, the second link 124, the third link 126 and the latch link 132, thereby setting the solar panel 140 for the desired tilt angle. Under the first application case (see FIG. 2), the right and of the chute 114 and the latch 136 both serve as the angle restriction mechanism.

Reference is made to FIG. 4 again, the through hole 126a and the third latch hole 126b extend along directions that are perpendicular to each other and intersected. That is, the through hole 126a and the third latch hole 126b have respective central axes perpendicular to each other and intersected.

When the floating solar panel erection structure 100 is switched from the first application case to the second application case, i.e., the case as illustrated in FIG. 3, the latch 136 is detached and an end of the solar panel 140 is lifted along a direction 142 so as to adjust a tilt angle of the solar panel 140 and move the angle adjustment mechanism 120 and the angle restriction mechanism 130 as well. When the angle adjustment mechanism 120 and the angle restriction mechanism 130 are switched to the second application case, the latch 136 is inserted into the aligned latch holes again.

FIG. 3 illustrates a side view of the floating solar panel erection structure in FIG. 1 in a second application case. Under the second application case, the solar panel 140 is tilted from the horizontal plane by about 20 degrees such the floating solar panel erection structure has better power generation performance under certain seasons or time, e.g., winter. Under the second application case, the sliding projection 134 is slid to an left end of the chute 114, and the third latch hole 126b of the third link 126 is aligned with the first latch hole 132a of the latch link 132. The latch 136 is inserted into the aligned latch holes to secure the position relationship among the first link 122, the second link 124, the third link 126 and the latch link 132, thereby setting the solar panel 140 for the desired tilt angle. Under the second application case (see FIG. 2), the left and of the chute 114 and the latch 136 both serve as the angle restriction mechanism. In addition, the solar panel 140 is erected on the second link 124 by means of two support rods (128a, 128b).

When the floating solar panel erection structure 100 is switched from the second application case to the first application case, the latch 136 is detached and the end of the solar panel 140 is pressed downwards along a direction 144 so as to adjust a tilt angle of the solar panel 140 and move the angle adjustment mechanism 120 and the angle restriction mechanism 130 as well. When the angle adjustment mechanism 120 and the angle restriction mechanism 130 are switched to the first application case, the latch 136 is inserted into the aligned latch holes again.

The first link 122, the second link 124, the third link 126 and the floating platform 110 are pivotally connected to each other to form a four-link mechanism (excluding the latch link 132) that is conducive to switch between the first and second application cases applying less forces, e.g., a single person is able to perform or only apply about ⅕ of the overall system weight. In order to optimize the power saving characteristics of the four-link mechanism, in the embodiment of the present disclosure, the length ratio of the first link 122, the second link 124 and the third link 126 is 3:8:7, but not being limited to this ratio.

Another design to optimize the power saving characteristics of the four-link mechanism is that the latch link 132 is perpendicular to the third link 126 and slidably connected within the through hole 126a and/or the through hole 126a is located at a bisected position of the third link 126, but not being limited to such design.

FIG. 5 illustrates a perspective view of a coupling device 150 according to one embodiment of the present disclosure. The first link 122, the second link 124, the third link 126 and the floating platform 110 are pivotally connected by the coupling device 150. The coupling device 150 includes a base portion 152, a pair of first and second projection portions (154, 156) extending from the base portion 152 and a pivot engaging mechanism 160. In this drawing, two pairs of first projection portion 154 and second projection portion 156 are interconnected and secured by the pivot engaging mechanism 160. The pivot engaging mechanism 160 includes a pivot rod 162 passing through the pair of first and second projection portions (154, 156) and two cap nuts 164 securing two opposite ends (which have thread structures, i.e., as illustrated in dash lines) of the pivot rod 162.

The floating solar panel erection structure disclosed herein is equipped with an angle adjustment mechanism that is conducive to manual adjustment. It can be observed that the solar panel has the characteristics that the higher the tilt angle in winter, the higher the efficiency of power generation while the lower the tilt angle in summer, the higher the efficiency of power generation. With this regard, a quarterly or semi-annual adjustment of a tilt angle may bring 2.5% to 3% of the power generation efficiency gain. And according to the wind power related design regulations, you can also understand the solar panels with lower tilt angles are conducive to wind or waves. Therefore, manually adjusting the tilt angle of the solar panel on the power generation platform has a certain degree of advantage in cost-saving.

In sum, the floating solar panel erection structure disclosed herein is equipped with a four-link mechanism as the angle adjustment mechanism, and equipped with the latch link and the sliding projection as the angle restriction mechanism so as to adjust the tilt angle for the solar panel under different application cases. Therefore, the floating solar panel erection structure is conducive to wind, waves or to have better power generation performance under certain seasons or time.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A floating solar panel erection structure comprising:
a floating platform comprising a chute, a first anchoring mechanism and a second anchoring mechanism;
an angle adjustment mechanism coupled to the floating platform, the angle adjustment mechanism comprising a first link, a second link and a third link that are pivotally connected to the floating platform, the first link and the third link having first ends pivotally connected to the floating platform, the second link having two opposite ends pivotally connected to second opposite ends of the first link and the third link, the second link is for erecting a solar panel thereon;
an angle restriction mechanism having a latch link to be coupled to the third link, and an end of the latch link is connected with a sliding projection which is slidably connected within the chute.

2. The floating solar panel erection structure of claim 1, wherein the latch link has a first latch hole and a second latch hole, and the third link has a through hole and a third latch hole, the latch link is perpendicular to the third link and slidably connected within the through hole, a latch is inserted to secure a position relationship among the first, second, third links and the latch link when the third latch hole is aligned with the first or second latch hole.

3. The floating solar panel erection structure of claim 2, wherein
the third latch hole is aligned within the first latch hole when the sliding projection is slid to a first end of the chute; and
the third latch hole is aligned within the second latch hole when the sliding projection is slid to a second end of the chute.

4. The floating solar panel erection structure of claim 2, wherein the through hole is located at a bisected position of the third link.

5. The floating solar panel erection structure of claim 2, wherein the through hole and the third latch hole extend along directions that are perpendicular to each other.

6. The floating solar panel erection structure of claim 1, wherein the chute has a lengthwise direction parallel to a horizontal plane when the floating platform is located on water.

7. The floating solar panel erection structure of claim 1, wherein the first, second, third links and the floating platform are pivotally connected by a coupling device.

8. The floating solar panel erection structure of claim 7, wherein the coupling device comprises a base portion, a pair of first and second projection portions extending from the base portion, and a pivot engaging mechanism.

9. The floating solar panel erection structure of claim 8, wherein the pivot engaging mechanism comprises a pivot rod passing through the pair of first and second projection portions and two cap nuts securing two opposite ends of the pivot rod.

10. The floating solar panel erection structure of claim 1, wherein the first link, the second link and the third link have a length ratio of 3:8:7.
